(19) United States
(12) Patent Application Publication
(10) Pub. No.: US 2007/0299673 A1
(43) Pub. Date: Dec. 27, 2007

(54) Back-end-loaded participatory real estate equity protection contract

(76) Inventors: Pieter Weyts, New York, NY (US); Michael Averbuch, Quincy, MA (US)

Correspondence Address: Pedro C. Fernandez;Cooper & Dunham LLP, 1185 Avenue of the Americas, New York, NY, 10036, US

(21) Appl. No.: 10/706,771

(22) Filed: Nov. 12, 2003

(51) Int. Cl. G06Q 10/00; G06Q 30/00

(52) U.S. Cl. 705/1

(57) ABSTRACT

A method of managing the risk of uncertainty of the future price levels of real estate property pursuant to a Back-End-Loaded Participatory Real Estate Equity Protection Contract or “BPREEPC.” One part of the invention grants the property owner the right to receive compensation in the event of a decline in the real estate index of the metropolitan area where the property is located. The property owner can only exercise this feature of the invention upon sale of the property to a third party. The amount of compensation equals a proportion of the value of the property as appraised at or about the time of the purchase of the put option, where the proportion is determined by the proportionate decline of the real estate market index, and where the amount of compensation may be capped at a certain amount. Another part of the invention grants the property owner a participatory payment upon sale of the property or at the end of the term of the BPREEPC in the event of an increase in the real estate index of the metropolitan area where the property is located. Such participatory payment may be a fixed amount as specified in the BPREEPC or may be determined as a certain rate of fee payable for the BPREEPC or a certain rate of the index appreciation since the purchase of the BPREEPC, where the maximum participatory payment may be capped at a certain amount. Under yet another part of the invention, the property owner is entitled to a non-exercise payment during the term of the BPREEPC in case the owner does not exercise the put option feature of the invention in the event of a decline of the real estate index of the metropolitan area where the property is located. Yet another feature of the invention involves the payment of a fee to the seller of the BPREEPC where such fee is payable upon the earlier of the sale of the property to a third party, or the refinancing of the mortgage loan that was entered into by the property owner for the purpose of acquiring the property.

### 1. FIELD OF THE INVENTION

The present invention relates to a method of offering protection to real estate property owners against the uncertainty of future price levels of the real estate market in which the property is located. Particularly, the invention relates to a method of providing compensation to the property owner upon sale of the property to a third party in the event of a decline in, and a participatory payment in the event of an increase in, the real estate index of the metropolitan statistical area in which the property is located.

### 2. BACKGROUND OF THE INVENTION

Real estate is one of the largest asset classes in the United States. Despite the importance of real estate for the U.S. economy, there is no effective manner in which real estate property owners can protect themselves against a decline in the real estate market over a time horizon specific to the real estate property owner.

Real estate prices have historically outpaced inflation in the United States. Price trends may be national or regional in nature. National price trends are largely driven by macroeconomic factors, such as the growth of the national gross domestic product, the state of the job market, and the level of mortgage interest rates. Regional price trends are driven by regional variations in supply and demand for real estate. The supply and demand in a particular region is determined by the state of the local economy, local demographic trends, the availability of land and local zoning laws.

Real estate property owners are faced with great uncertainty about the future price levels and volatility of the local real estate market. The present invention addresses the market demand for a product that protects real estate property owners and real estate property buyers against this uncertainty. This demand is fueled by several factors.

First, there may be a market perception that the local real estate market is over-valued at a given point in time. When real estate prices are high after a period of economic expansion, people become fearful that the price levels may not be sustainable. Such negative market sentiment may be further fueled by a slowing growth in home prices, an unfavorable job market, anxiety over potential job loss, or memories of price bubbles of the past. Under these circumstances, property owners are fearful that they may lose some or all of their accumulated capital gains on their real estate. When there is no sure way of protecting these gains, some people may decide to sell their home, even though such sale would not be their preferred course of action if there were other options available to lock in their capital gains.

Second, for many people a large percentage of their personal wealth is concentrated in real estate. For example, for most people, the purchase of their home is their greatest single investment and asset in their entire life. Good financial management requires diversification of assets in order to maximize returns. But in the case of real estate investments, there is no effective way of diversifying the portfolio short of selling the real estate and re-allocating the assets to investments where a greater degree of diversification can be achieved.

Third, real estate property owners may be concerned about the prospect of being forced to sell the property at a loss after a significant market decline. While real estate may have appreciated considerably on a historical basis, a volatile economic environment may make real estate occupancy time horizons increasingly unpredictable. For example, in the residential real estate market, several circumstances may force homeowners to sell their homes in the future even when prices have declined: professional residency requirements or other relocations for professional reasons, fixed-term employment contracts, adverse personal financial conditions, or family reasons. Given the potential of a future forced or planned sale, property owners may decide to sell their property despite the legal costs and inconvenience associated with such a sale. Potential real estate buyers, on the other hand, may decide to stay out of the real estate market by fear that they will be forced to sell at a loss, thereby foregoing the benefits of ownership, such as tax deductions of mortgage payments or the potential for tax-free capital gains.

Fourth, the real estate market has a limited supply of hedging products as compared to other markets. Unlike real estate investors, stock market investors can buy a multitude of financial products to hedge their financial exposure. For example, there is an active options market on a great number of stocks, which allows stockholders to lower the risk on their portfolios. By contrast, real estate investors do not have any such hedging products at their disposal.

Several initiatives have been taken to address the market need for protection against a potential downside in the residential real estate market. The existing initiatives are of two kinds: exchange-listed futures and real estate equity protection contracts that are not traded on an exchange. Another initiative launched in the United Kingdom has offered betting opportunities on average house prices as determined by a local, regional, or national index in the United Kingdom. We do not consider the latter initiative relevant for this application.

We are aware of two start-up initiatives that offer homeowners the opportunity to purchase futures, contracts on a real estate index: the AeFT Exchange in Los Angeles, Calif. and City Index Property Futures in London, England. A futures contract is a forward contract that is ordinarily traded on an exchange. A forward contract is an agreement to buy or sell an asset at a certain future time for a certain price. These two initiatives allow, or are trying to implement a system to allow, customers to buy or sell real estate positions in the future. The present invention can be distinguished from these initiatives of exchange-listed futures in three important respects. First, the present invention is not an agreement to buy or sell an asset at a certain future time for a certain price and is therefore not a forward contract. Second, the present invention is not a product that will be traded on an exchange. Third, the present invention provides for compensation both in case of a decrease in the index (through the put option feature or the non-exercise payment feature), and in case of an increase in the index (through a participatory payment feature).

We are aware of one initiative that offers homeowners a program that would protect some or all of their home equity. Real Liquidity, LLC currently offers a product that is meant to provide long-term protection to homeowners that live in the Syracuse, N.Y. area (the “Syracuse project”). For a single, up-front fee a homeowner can purchase protection against future declines in the value of their local residential real estate market, as measured by an index for the homes with the same zip code. The product is available to current owner-occupants of one and two-family homes, and may be purchased for any declared home value. Claims will be paid out to homeowners who have owned the property for at least 3 years. The total protection term is thirty years.

There is no existing product which offers real estate owners the right to receive compensation upon sale of the property to a third party in the event of a decline of the real estate index of the metropolitan statistical area in which the property is located (i.e., the put option feature) or the right to receive a participatory payment in the event of an increase in the index of the real estate market in which the property is located (i.e., the participatory feature), or the right to receive a non-exercise payment in case the owner does not exercise the put option feature and the index has declined from its initial level (i.e., the non-exercise payment feature), in exchange for a fee which is only payable upon sale or refinancing of the property.

As a result, the present invention proposes a new process to serve real estate property owners whereby the owner would receive such rights under a contract referred to as a Back-End-Loaded Participatory Real Estate Equity Protection Contract or “BPREEPC.”

### SUMMARY OF THE INVENTION

The present invention relates to a method of offering protection to real estate property owners against the uncertainty of future price levels of the real estate market in which the property is located. Particularly, the invention relates to a method of providing compensation to the property owner upon sale of the property to a third party in the event of a decline of the real estate index of the metropolitan area in which the property is located (i.e., the put option feature), and the right to receive a participatory payment upon sale of the property or at the end of the term of the BPREEPC in the event of an increase in such index (i.e., the participatory feature), and the right to receive compensation during the term of the BPREEPC in case the owner does not exercise the put option feature of the invention and the index has declined from its initial level (i.e., the non-exercise payment feature), in exchange for a fee which is only payable upon sale or refinancing of the property. The written contract that forms the basis of the present invention is referred to as a Back-End-Loaded Participatory Real Estate Equity Protection Contract, or a “BPREEPC.”

### DETAILED DESCRIPTION OF THE INVENTION

Reference will now be made in detail to the preferred embodiments of the invention, examples of which are also provided in the following description. Exemplary embodiments of this invention are described in some detail, although it will be apparent to those skilled in the relevant art that some features which are not particularly relevant to the invention may not be shown for the sake of clarity. Therefore, the examples provided below are primarily given in the context of residential home sales. Nevertheless, it should be obvious that the invention also contemplates applications in the commercial real estate market.

In the preferred embodiment of the present invention, a real estate property owner purchases the right to receive compensation upon sale of the property to a third party in the event of a decline of the real estate index of the metropolitan statistical area in which the property is located (i.e., the put option feature), and the right to receive a participatory payment upon sale of the property or at the end of the term of the BPREEPC in the event of an increase in such index (i.e., the participatory feature), and the right to receive compensation during the term of the BPREEPC in case the owner does not exercise the put option feature of the invention and the index has declined from its initial level (i.e., the non-exercise payment feature), in exchange for a fee which is only payable upon sale or refinancing of the property. For the purposes of this disclosure, the written contract that forms the basis of the present invention is referred to as a Back-End-Loaded Participatory Real Estate Equity Protection Contract, or a “BPREEPC.”

The BPREEPC may have a term ranging from two to ten years. The level of the real estate index is measured at the end of the month, quarter or year in which the BPREEPC was purchased and at the end of the month, quarter or year in which the property is sold (for the put option feature and participatory feature) or in which the BPREEPC expires (for the participatory feature).

At the time of purchase of the BPREEPC, the property owner executes a legally binding document that places an encumbrance on the title of the property requiring satisfaction of the payment of the fee. When the purchaser of the BPREEPC does not sell or refinance the property during the term of the BPREEPC, the purchaser starts to incur interest on the fee starting at the end of the term of the BPREEPC.

In the preferred embodiment of the invention, the participatory payment may be a fixed amount as specified in the BPREEPC or may be determined as a proportion of the fee payable by the purchaser of the BPREEPC or as a certain rate of the index appreciation, where the maximum participatory payment may be capped at a certain amount.

In one feature of the present invention, a property owner purchases the right to receive compensation in the event of a decline in the real estate index of the locality where the property is situated at the time the property owner sells the property to a third party (i.e., the put option feature of the invention). The index is a local index which covers the metropolitan statistical area (MSA) in which the property is located. The put option feature of the BPREEPC cannot be exercised simply upon a decline in the index. Rather, the put option feature can only be exercised upon sale of the property by the property owner to a third party.

This feature of the present invention ensures that the property owner has protection against a decline in the real estate market at a time when the owner would most likely be subject to a loss upon sale of the property as a result of such decline. In addition, the put option feature can only be exercised during the term of the BPREEPC, which may range from two to ten years. A BPREEPC offers immediate protection starting at the time of purchase of the BPREEPC. When the property owner has not exercised the option feature of the BPREEPC during the term of the BPREEPC, the put option feature lapses.

BPREEPCs will expire after a certain term ranging from two to ten years. The average life of a mortgage loan in the United States is about seven years. Therefore, the range of possible terms of BPREEPCs would cover the life of the mortgage of a large number of property owners.

Generally, any period of significant decline in the real estate market would be followed by a period of recovery. For example, if the real estate market declines in the first five years, it is likely to experience an upswing or recovery in the following five years. The cyclical nature of the real estate market with its recoveries over the long run wipes out the benefit of a BPREEPC with a term longer than ten years.

When the property owner decides to exercise the put option feature of the BPREEPC upon sale of the property, the owner is entitled to compensation in the event the index has declined from the initial level at the time of purchase of the BPREEPC. The amount of the compensation is a proportion of the appraised value of the property at or about the time of purchase of the BPREEPC. The proportion of the property value is determined by the proportionate decline of the real estate market index.

In another feature of the present invention, the purchaser of the BPREEPC is entitled to a participatory payment at the end of the term of the BPREEPC or upon sale of the property in the event the index has increased since the purchase of the BPREEPC and the purchaser of the BPREEPC has not exercised the option feature of the BPREEPC before such time. This is a critical feature of the invention because it ensures participation by the purchaser of the BPREEPC in the upside of the real estate index, if any, while at the same time offering protection against any decline. Therefore, when the index increases, the property owner may gain in two ways. First, the property owner will likely accumulate capital gains on the property that are associated with such increase in the index. Second, the property owner will be entitled to compensation under the participatory payment feature of the BPREEPC. The participatory payment may be made in cash but may take a wide variety of forms. For example, the participatory payment could take the form of a rebate on the real estate commission to be paid upon sale of the property. Or the participatory payment could take the form of a discount on a renewal of the BPREEPC for a new period in which the property owner wants to be protected against any decline in the real estate market. Obviously, there are many forms that the participatory payment may take that would be acceptable to the purchaser of the BPREEPC.

In yet another feature of the present invention, the purchaser of the BPREEPC is entitled to a non-exercise payment during the term of the BPREEPC in the event the purchaser has not exercised the put option feature of the BPREEPC and the index has declined since the purchase of the BPREEPC and provided the conditions that may be specified in the BPREEPC are satisfied.

Yet another feature of the invention involves the payment of a fee to the seller of the BPREEPC where such fee is payable upon the earlier of the sale of the property to a third party, or the refinancing of the mortgage loan that was entered into by the property owner for the purpose of acquiring the property. This is a critical feature of the invention because the purchaser of the BPREEPC is not faced with an upfront cost associated with the purchase of the BPREEPC.

A prospective BPREEPC purchaser who would be required to pay an upfront fee in the amount of a certain percentage of the property value is unlikely to purchase the BPREEPC. The cash outlay at the time of purchase would be simply too great for most property owners. By contrast, when the fee for the BPREEPC is only payable upon sale of the property or refinancing, there is no need to finance the BPREEPC. The fee would simply be paid out of the cash distribution to the property owner at the time of sale or, in case of refinancing, the fee would be rolled into the primary mortgage loan. This payment structure avoids requiring an immediate cash outlay out of the property owner's budget.

Also, under the proposed invention, when the purchaser of the BPREEPC does not sell or refinance the property during the term of the BPREEPC, the purchaser starts to incur interest on the fee starting at the time of expiration of the term of the BPREEPC.

In addition, at the time of purchase of the BPREEPC, the property owner must execute a legally binding document that secures payment of the fee to the seller of the BPREEPC at the time of sale or refinancing of the property.

Because the risk of non-payment is lower as a result of this requirement, the seller of the BPREEPC can afford to charge a lower fee for the BPREEPC than without such requirement. There may be various ways in which the seller of the BPREEPC may secure payment of the fee. The most likely manner, however, would be the execution of a secondary lien on the real estate property that the owner seeks to protect in the amount of the fee payable.

The property value appreciation or decline as a function of the appreciation or decline of the index is measured using a Property Value Metric (“PVM”). The PVM is a decimal index which is set at 1.00 at the time of purchase of the BPREEPC and which tracks the subsequent decline or appreciation of the real estate index on which the BPREEPC is based for the term of the BPREEPC. For example, when the level of the index upon sale is 20% lower than the index level at the time of purchase of the BPREEPC, the PVM will be 0.80 and the property owner will be entitled to 20% of the appraised value of the property.

The following formula describes the measurement of the appreciation or decline of the index using the PVM:

p₀=1.00 (i.e., 100%)
At the time of each index release, pᵢ is marked to market as follows:

$${p}_{i} = {p}_{0} \times \frac{{I}_{i}}{{I}_{0}}$$

Where:
Iᵢ=House Price Index for the Metropolitan Statistical Area at time i
Iₒ=House Price Index for the Metropolitan Statistical Area, at the end of the month, quarter or year in which the BPREEPC was purchased
p₀=Property Value Metric at the time BPREEPC was purchased=1.00
   pᵢ=Property Value Metric at time i
   i=Time of index release

In the preferred embodiment of the invention, the decline or appreciation will be measured from the end of the month, quarter or year in which the BPREEPC was purchased until the end of the month, quarter or year in which the property was sold. However, the BPREEPC may provide for alternative times at which the initial and final levels of the index may be determined. The seller of the BPREEPC may rely on a variety of sources in appraising the value of the property at the time the seller of the BPREEPC sold the BPREEPC to the property owner.

The proposed invention satisfies an urgent need among real estate property owners. In particular, BPREEPCs would allow property owners to manage the risk associated with the uncertainty of the price level and volatility of the real estate market in which their property is located. BPREEPCs would address both the temporary and permanent factors that fuel the need of real estate property owners for protection against significant short-term or medium-term declines in the real estate market.

First, the proposed invention would alleviate the fears of an overvalued real estate market. Property owners who purchased a BPREEPC would no longer have to fear a price correction in the short-term or medium-term. In case the market declines, they would be entitled to compensation under the put option feature or the non-exercise payment feature of the BPREEPC.

In case the market appreciates, they would not only realize capital gains that are likely to be associated with such price appreciation, but also receive a participatory payment under the BPREEPC. In either case, they would not be faced with an upfront fee as the fee is only payable upon sale or refinancing of the property.

Second, property owners who have accumulated significant capital gains in recent years no longer need to sell their property in order to lock in those gains. Rather than selling the property and incurring various legal, brokerage and other costs associated with such sale, property owners can hold on to their property while incurring the liability of paying the fee for the BPREEPC when the owner sells or refinances the property.

Third, property owners who have a large share of their investment portfolio concentrated in real estate finally would have a way to protect that wealth without having to sell the property. This would help them achieve a more balanced, lower-risk portfolio. Property owners can continue to reap the benefits of investing in real estate, including any gains associated with a market appreciation, while resting assured that the potential downside of their real estate holdings is protected for the term of the BPREEPC, and without incurring any upfront payment.

Fourth, property owners whose financial situation would deteriorate as a result of, or at the same time as, a decline in the real estate market and who would be forced to sell their real estate property at a loss are entitled to a cash distribution from exercising the put option feature of the BPREEPC, or from a non-exercise payment, at a time when funds are needed the most.

Finally, the BPREEPC is of great utility to a great number of homeowners and real estate investors. Various other products could be designed to provide protection to property owners in the case of decline; for example, the real estate equity protection contracts offered in the Syracuse project, as described above. However, these products would not have the required features that would make these products attractive in the same manner and to the same extent as the present invention.

A BPREEPC has nine distinctive features that would likely generate great interest from property owners.

First, the put option feature of a BPREEPC is exercisable upon sale of the property. This feature ensures that protection is offered when the protection is most needed, i.e., when the property owner would incur a loss.

Second, a BPREEPC is linked to the real estate index of the metropolitan statistical area where the property is located. This feature ensures that the offered protection tracks the housing price trend of the locality where the property is situated.

Third, a BPREEPC offers immediate protection starting at the time of purchase of the BPREEPC.

Fourth, a BPREEPC may have a term ranging from two to ten years, which covers the period of time in which property owners would be most likely to incur a loss upon sale of their property.

Fifth, the initial level of the index is measured at the end of the month, quarter or year in which the BPREEPC was purchased and the final level of the index is measured at the end of the month, quarter or year in which the property is sold (for the put option feature and participatory feature) or in which the BPREEPC expires (for the participatory feature). At or about the beginning of the term of the BPREEPC, the initial PVM of 1.00 is set to the level of the index as measured at that time. For the term of the BPREEPC, the PVM tracks the real estate index on which the BPREEPC is based. As the index declines or appreciates, the level of the PVM is adjusted at each index release to reflect the most current real estate market conditions. The current status of the PVM, of which the property owner could be periodically informed, would allow the property owner to closely track the status of the BPREEPC, thereby improving the transparency of the BPREEPC.

Sixth, the purchaser of a BPREEPC is not faced with an immediate up-front cost. Rather, the fee would be paid out of the cash distribution to the property owner at the time of sale or, in case of refinancing, the fee would be rolled into the primary mortgage loan. This payment structure avoids requiring an immediate cash outlay out of the property owner's budget.

Seventh, the property owner must execute a legally binding document that places an encumbrance on the title of the property requiring satisfaction of the payment of the fee at the time of sale or refinancing of the property. This feature of the invention secures payment of the fee to the seller of the BPREEPC and thereby decreases the fee at which the seller of the BPREEPC can offer the BPREEPC to the property owner.

Eighth, under a BPREEPC, in case the index increases from the level at or about the time of purchase of the BPREEPC, the property owner is entitled to a participatory payment upon sale of the property or upon expiration of the BPREEPC. As a result, property owners do not simply lose the cost of the BPREEPC in case the index increases. Instead, property owners share in the upside of the index by receiving a participatory payment in addition to the capital gains that are most likely realized upon an increase in the index.

Finally, under a BPREEPC, the property owner would be entitled to a non-exercise payment in case the index declines and the owner does not exercise the put option feature and provided the conditions that would be specified in the BPREEPC are satisfied. As a result, property owners do not simply lose the cost of the BPREEPC in case the property owner does not exercise the put option feature of the BPREEPC. Instead, the owner may recover part of the fee for the BPREEPC.

All these features are unique, novel and innovative ways that make the present invention highly attractive for all homeowners who care about maintaining and preserving their wealth. Each of the components of the preferred embodiment of a BPREEPC is described in greater detail below: put feature, participatory payment feature, non-exercise payment feature and fee payable.

### A. Put Feature

Under a BPREEPC, a real estate property owner has the right to receive a certain amount of compensation in the event of a decline of the real estate index at a certain time. This feature of a BPREEPC is similar to any put option on an index.

The holder of a traditional put option on an index has the right to receive an amount in proportion to the difference between the exercise price (or strike price) of the option and the level of the index at a certain point in time, provided the level is lower than the exercise price.

The writer of a put option is required to pay this amount in cash to the holder of the put option. Similarly, when the index declines, the purchaser of a BPREEPC is entitled to a cash payment upon sale of the property during the term of the BPREEPC. However, the put option feature of a BPREEPC has several distinguishing characteristics as compared to a traditional put option on an index.

First, under a traditional index put option, the option is unrelated to any property of the purchaser of the put option. In addition, the prospective purchaser of a traditional put option can purchase a put option with any exercise price that is offered on the market. By contrast, under a BPREEPC, the value that a purchaser of a BPREEPC can protect is determined by the appraised value of the real estate property at or about the time of purchase of the BPREEPC.

Second, the number of options that a prospective purchaser of traditional put options may buy is unlimited. The more put contracts the put holder buys, the more compensation the put holder will receive in case of a decline of the index. By contrast, in the case of the put option feature of a BPREEPC, the compensation that the purchaser of a BPREEPC can receive is always limited to a share of the appraised value of the real estate property at or about the time of purchase of the BPREEPC. The size of the share of the appraised value of the property that the purchaser of the BPREEPC receives is determined by the proportionate decline in the real estate index and any maximum amount of compensation as may be specified in the BPREEPC.

Third, the index upon which a BPREEPC is based is the house price index of the real estate market of the metropolitan statistical area (MSA) where the property of the purchaser of the BPREEPC is located, as published by the Office of Federal Housing Oversight.

In its preferred embodiment, the BPREEPC is designed to work specifically with this index, which is released quarterly. Put options on this type of index have not yet been offered in the market. The index accurately reflects the dynamics of the market where the protected property is located. Also, it is highly improbable that the integrity of this index will be compromised, as it is published by a federal agency based on the property sales data streamed by FREDDIE MAC. In addition, the index is computed using property sales data of an entire MSA, which may be a more accurate reflection of the overall local price trends than smaller geographical units such as areas tied to a zip code due to the larger sample size of property sales data.

Fourth, traditional index options are generally one of two kinds: European style or American style. A European style option allows the holder of the option to exercise the option only at the end of the life of the option. An American style option allows the holder of the option to exercise the option at any time during the life of the option. The put option feature of a BPREEPC does not fall in either category. The put option feature of BPREEPC can only be exercised under one circumstance: upon sale of the property.

Fifth, the term of a BPREEPC distinguishes it from a traditional put option on an index. The life of traditional put options is relatively short, i.e., several months, and in certain cases, one or two years. By contrast, the term of a BPREEPC may range from a period of two to ten years from the time of the purchase of the BPREEPC. As described above, this term corresponds to the average time horizon of most real estate property owners.

Sixth, the cash payment made under a traditional put option on an index is based on the index value at the end of the day on which the exercise instructions are issued. In the preferred embodiment of the put option feature of a BPREEPC, the index value is measured from the end of the month, quarter or year in which the property owner purchases the BPREEPC until the end of the month, quarter or year in which the property owner sells the property.

Finally, there are significant differences between the premium paid for a traditional put option and the fee paid for a BPREEPC, as described in greater detail below.

The PVM is a decimal index which is set at 1.00 at the time of purchase of the BPREEPC and which tracks the subsequent decline or appreciation of the real estate index on which the BPREEPC is based for the term of the BPREEPC as illustrated in the following example.

### EXAMPLE 1

The initial housing index level is 250. The PVM for the BPREEPC is initially set to 1.00. At the end of the next quarter, the housing index advances to 255, representing a 2.0% rise in the index over the initial level. Therefore, the PVM is adjusted to 1.02. The following quarter, the housing index rises to 265, representing a 3.9% percent rise quarter-over-quarter, but a 6.0% rise over the initial index level. Accordingly, the PVM is adjusted to 1.06.

The following examples illustrate how the put feature of the BPREEPC functions.

### EXAMPLE 2

On Feb. 14, 2004, Jerry purchases a BPREEPC with a term of ten years. At the time of purchase of the BPREEPC, the value of Jerry's home is $300,000. The BPREEPC provides that the initial index level is determined at the end of the calendar quarter in which the BPREEPC is purchased. At the end of the quarter on Mar. 31, 2004, the index level is 250. As a result, the initial PVM of 1.00 is set at the index level of 250. On Jun. 30, 2004, the index value drops to 245, i.e., a 2% decline. This means that the PVM at that time is reset to 0.98. More than two years later, on Jul. 4, 2006, which is before the expiration of the term of the BPREEPC, Jerry sells his home. At the end of the quarter, on Sep. 30, 2006, the index level is 200. At such time, the PVM is reset to 0.80, reflecting a 20% decline from the initial index level. Because the appraised value of Jerry's home at the time of purchase of the BPREEPC was $300,000, Jerry is entitled to a payment of $60,000, i.e., 20% of the appraised value.

### EXAMPLE 3

On Feb. 14, 2004, George purchases a BPREEPC with a term of five years. The BPREEPC provides that the initial index level is determined at the end of the calendar quarter in which the BPREEPC is purchased. At the end of the quarter on Mar. 31, 2004, the index level is 250. The initial PVM of 1.00 is set at this index level. On Feb. 14, 2009, the term of the BPREEPC expires. On Mar. 20, 2009, George sells his home. On Mar. 31, 2009, the level of the index is 150, and the PVM is at 0.60, i.e., a 40% decline against the initial index level. Because George sold his home after expiration of the term of the BPREEPC, he is not entitled to any compensation under the put feature of the BPREEPC.

### B. Participatory Feature

In the preferred embodiment of the present invention, the purchaser of a BPREEPC is entitled to a participatory payment in the event of an increase in the index level at the end of the term of the BPREEPC or upon sale of the real estate property.

The increase, if any, of the index is measured from the end of the month, quarter or year in which the property owner purchased the BPREEPC until the end of the month, quarter or year in which the property was sold or the term of the BPREEPC ended.

The participatory payment may be a fixed amount as specified in the BPREEPC. Alternatively, the participatory payment could be a certain percentage of the fee payable to the seller of the BPREEPC or a percentage of index appreciation since the purchase of the BPREEPC. The BPREEPC may provide for alternative ways in which the participatory payment may be structured. In addition, the BPREEPC may specify a maximum amount of the payout under the participatory payment feature of the BPREEPC.

The timing of the participatory payment may coincide with either the expiration of the term of the BPREEPC or the sale of the property in the event the index has increased since the purchase of the BPREEPC.

The following example illustrates how the participatory feature functions.

### EXAMPLE 4

On Feb. 14, 2004, Elaine purchases a BPREEPC with a term of five years. The BPREEPC specifies that the purchaser of the BPREEPC is entitled to a participatory payment of $5,000 when the PVM at expiration is higher than the initial PVM. The BPREEPC also provides that the initial index level is determined at the end of the calendar quarter in which the BPREEPC is purchased.

At the time of purchase of the BPREEPC, the value of Elaine's home is $300,000. At the end of the quarter on Mar. 31, 2004, the index level is 250. As a result, the initial PVM of 1.00 is set at the index level of 250. On Feb. 14, 2009, the term of the BPREEPC expires.

At expiration, Elaine has not yet sold nor refinanced her home. The BPREEPC provides that the final index level is determined at the end of the calendar quarter in which the term of the BPREEPC expires. On Mar. 31, 2009, the index value is 300, i.e., a 20% increase. This means that the PVM at that time is reset to 1.20. Because the PVM at expiration is higher than the initial PVM, Elaine is entitled to $5,000.

### C. Non-Exercise Payment Feature

In the preferred embodiment of the present invention, the purchaser of a BPREEPC may be entitled to a non-exercise payment during the term of the BPREEPC in the event the purchaser has not exercised the put option feature of the BPREEPC and the index has declined since the purchase of the BPREEPC and provided the conditions that may be specified in the BPREEPC are satisfied. The non-exercise payment may be a fixed amount as specified in the BPREEPC. Alternatively, the non-exercise payment could be a certain percentage of the fee payable to the seller of the BPREEPC or a percentage of index appreciation since the purchase of the BPREEPC. The BPREEPC may provide for alternative ways in which the non-exercise payment may be structured. In addition, the BPREEPC may specify a maximum amount of the payout under the non-exercise payment feature of the BPREEPC.

The following example illustrates how the non-exercise payment feature functions.

### EXAMPLE 5

On Feb. 14, 2004, Kramer purchases a BPREEPC with a term of five years. The BPREEPC specifies that the purchaser of the BPREEPC is entitled to a non-exercise payment of $3,000 upon expiration of the BPREEPC when the PVM at expiration is lower than the initial PVM and the property has not been sold. The BPREEPC also provides that the initial index level is determined at the end of the calendar quarter in which the BPREEPC is purchased.

At the time of purchase of the BPREEPC, the value of Kramer's home is $300,000. At the end of the quarter on Mar. 31, 2004, the index level is 250. As a result, the initial PVM of 1.00 is set at the index level of 250. On Feb. 14, 2009, the term of the BPREEPC expires.

The BPREEPC provides that the final index level is determined at the end of the calendar quarter in which the term of the BPREEPC expires. On Mar. 31, 2009, the index value is 200, i.e., a 20% decline. This means that the PVM at that time is reset to 0.80. Because the PVM at expiration is lower than the initial PVM and Kramer did not sell his property, he is entitled to $3,000.

### D. Fee Payable

Generally, the purchaser of a traditional put option must pay a premium upon purchase of the put option. Also, real estate equity protection contracts that are part of the prior art require an upfront payment of a premium. By contrast, in the preferred embodiment of the present invention, the seller of the BPREEPC is entitled to a fee which is payable upon the earlier of the sale of the property to a third party, or the refinancing of the mortgage loan that was entered into by the property owner for the purpose of acquiring the property.

This feature of the BPREEPC is critical in making the BPREEPC a product that real estate property owners would be interested in purchasing. The absence of any upfront payment wipes out any concerns about financing the purchase of the BPREEPC.

In this manner, the payment of the fee is deferred until a time at which it is most easy for the purchaser of the BPREEPC to make the cash outlay for the payment of the fee. The purchaser of the BPREEPC could postpone the payment of the fee indefinitely by not selling or refinancing the property.

The purchaser of the BPREEPC does not incur any interest on the fee for the term of the BPREEPC. When the purchaser of the BPREEPC does not sell or refinance the property during the term of the BPREEPC, the purchaser starts to incur interest on the fee starting at the time of expiration of the term of the BPREEPC, at an interest rate as may be specified in the BPREEPC. The main function of this interest feature is to protect the value of the premium for the seller of the BPREEPC against inflation. In order to secure payment of the fee by the property owner to the seller of the BPREEPC upon sale or refinancing, in the preferred embodiment, a document is signed by the parties at the time the BPREEPC is purchased.

The document, which may be notarized, may be recorded in public records along with the property records such as the title. Local laws may vary with respect to the contents and restrictions of such a document, notarizing requirements, and recordation requirements and procedures. Consequently, applicable local laws should be considered.

The BPREEPC would then appear in any title search as an encumbrance on the property title requiring satisfaction before ownership of the property may be validly transferred. As a result, any property owner with a BPREEPC who would want to sell the property, would be required to satisfy the owner's obligation under the BPREEPC. The seller of the BPREEPC, or the seller's transferee, successor or assignee, would be notified by, for example, one of the parties to the sale or a lending institution that the property was being conveyed. The seller of the BPREEPC, or the seller's transferee, successor or assignee, could then be compensated and the title cleared.

The following example illustrates how the fee payable feature functions.

### EXAMPLE 6

On Feb. 14, 2004, Newman purchases a BPREEPC with a term of five years. At the time of purchase of the BPREEPC, the value of Newman's home is $300,000. Newman agrees to purchase a BPREEPC for 3% of the appraised value of his home payable upon sale or refinancing of his home.

Newman allows a lien to be placed on his home in the amount of $10,000, or 3% of the appraised home value, in favor of the seller of the BPREEPC.

On Feb. 14, 2009, the term of the BPREEPC expires. At expiration, Newman has not yet sold nor refinanced his home. The BPREEPC specifies that the purchaser will accrue 5% annual interest on the fee payable starting at expiration of the BPREEPC and until the earlier of the sale of the property, or settlement of the fee in cash by the purchaser. On Feb. 15, 2010, Newman sells his house. At closing, a check for $10,500 (base fee+1 year interest) is issued to the seller of the BPREEPC.

In the preferred embodiment of the present invention, the amount of the fee that the purchaser of the BPREEPC is required to pay will depend on a wide variety of factors including, but not limited to, the value of the underlying real estate property, the estimated holding period for the property, historical data and estimated future levels of the index levels of the MSA in which the property is located, macro-economic factors such as expected unemployment rate, expected growth rate of the gross domestic product, the level of mortgage interest rates, demographic trends, and local zoning laws and regulations.

The future level or scope of these factors can be estimated within a reasonable degree of statistical certainty using data from a wide variety of sources. Sophisticated simulation models may be designed to estimate more accurately the future levels of these factors.

The following formulas describe the payouts under the put feature and the participatory feature of the present invention:

Payout to the property owner upon sale of the property or expiration of the BPREEPC at time t:
a) where Iₜ≧I₀:
   i) upon sale of the property:

V=Sₜ−M−F+B
OR
ii) upon expiration of the term of the BPREEPC:

V=B
where
   B=F×r_{participatory payment}, where B is capped at Bₘₐₓ
   OR
   B=(S₀×PVMₜ−S₀)×r_{participatory payment}, where B is capped at Bₘₐₓ
   OR
   B=pre-negotiated flat participatory payment
b) where Iₜ<I₀: upon sale of the property:
   The lower of:

V=Sₜ−M−F+(S₀−pₜ×S₀)
OR
V=Vₘₐₓ

Where:
V=payout to the property owner
Vₘₐₓ=imum payout under the put-feature as specified in the BPREEPC
Sₜ=perty sales price
S₀=raised property value at or about the time of purchase of the BPREEPC
M=property owner's mortgage balance
Iₜ=House Price Index for the Metropolitan Statistical Area at the end of the month, quarter or year in which the property was sold or the term of the BPREEPC expired
I₀=House Price Index for the Metropolitan Statistical Area at the end of the month, quarter or year in which the BPREEPC was purchased
PVMₜ=Property Value Metric at the end of the month, quarter or year in which the property was sold or the term of the BPREEPC expired
B=Participatory payment to the purchaser of the BPREEPC
r_{participatory payment}=Participatory payout rate as a function of the index appreciation or as a function of the fee payable to the seller of the BPREEPC
F=Fee payable to the seller of the BPREEPC
t=the end of the month, quarter or year in which the property was sold or the term of the BPREEPC expired
Bₘₐₓ=imum participatory payment as specified in the BPREEPC
   The written agreement that forms the basis of the BPREEPC may take a wide variety of forms, within the parameters of applicable law, and the present invention is not limited to any one specific form of agreement, nor is it limited to any particular choice of language.

There are a great many provisions that may be incorporated into the written BPREEPC contract. Among the provisions that may optionally be included is a provision governing whether the BPREEPC transfers with the property in the event the owner bequeaths the property to his heirs instead of selling it (i.e., whether the owner's heirs are entitled to the rights under the BPREEPC).

In the preferred embodiment of the invention, the BREEPC contains four components: the put option feature, the participatory payment feature, the non-exercise feature and the fee payable. However, it will be obvious to anyone skilled in the art that a contract could be composed which contains less than all four components.

The obligation to pay a fee to the seller of BPREEPC at sale or refinancing of the property may be securitized in the financial markets. Securitization is the method of financing cash flows generated from pooled, structurally similar assets.

In the past 20 years, securitization techniques have become widely applied to a variety of assets, such as residential mortgages, credit card payments, and accounts receivables. An asset is fit for securitization if the cash flows have been engineered to conform to pre-established standards, and if the cash flows from the assets are statistically predictable.

The fee payable to the seller of the BPREEPC represents an asset with a future cash flow, which lends itself well to the asset-backed securitization process.

The structure and mechanics of BPREEPC methods and procedures can be automated using a combination of custom and off-the-shelf computer software. The system could implement all business methods described within this application, including calculating the “fee payable” as a function of property appraisals and customer profiles, processing contract exercise claims, tracking the PVM at any given point in time during the term of the BPREEPC and disclosing the PVM to the purchasers of a BPREEPC, calculating the participatory payment payable to the BPREEPC holder, performing Client Relationship Management (CRM) functions, and generating and maintaining Standard Operating Procedure (SOP) documentation.

In addition, financial calculators based on BPREEPC structure and methods may be provided to prospective buyers via the Internet or any other form of distribution for the purpose of self-assessment of the product's applicability to individually-tailored scenarios and situations.

It will be obvious to anyone skilled in the art that the present invention can be employed in a wide variety of embodiments. The preferred and exemplary embodiments of the invention have been described in some detail, but it will be apparent to those skilled in the relevant art that some features which are relevant to the invention may not have been described for the sake of clarity. While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

We claim:

1. A back-end-loaded participatory real estate equity protection contract, wherein:
a contract writer agrees to pay a beneficiary a payout,
the payout is determined by an index level representing a price level of real estate properties in a predetermined area where the beneficiary owns a real estate property,
the right of the beneficiary to receive the payout is exercised upon a sale of the real estate property during a term of the contract, and
the beneficiary agrees to pay the contract writer a fee.

2. The contract according to claim 1, wherein the beneficiary is entitled to the payout in case the index level decreased since the contract was entered into.

3. The contract according to claim 1, wherein the term of the contract ranges from two to ten years.

4. The contract according to claim 1, wherein the payout is a proportion of an appraised value of the real estate property at about a time when the contract was entered into.

5. The contract according to claim 1, wherein when the real estate index declines since a time the contract was entered into, the payout is a proportion of an appraised value of the real estate property at about the time when the contract was entered into and wherein the proportion is determined by a decline of the index level since the time when the contract was entered.

6. The contract according to claim 1, wherein the fee is paid upon the earlier of the sale of the real estate property or a refinancing of a mortgage loan on the real estate property.

7. The contract according to claim 1, wherein a legally binding document is executed placing an encumbrance on a title of the real estate property requiring satisfaction of the fee payable to the contract writer upon the earlier of the sale of the real estate property or a refinancing of a mortgage loan on the real estate property.

8. The contract according to claim 1, wherein the beneficiary incurs interest on the fee payable starting at the end of the term of the contract until the fee has been paid in full, when the property has not been sold or refinanced during the term of the contract.

9. The contract according to claim 1, wherein the index is the index of an average sales price of residential real estate in a metropolitan statistical area where the real estate property is located.

10. The contract according to claim 1, wherein the index level of the index is measured from an end of the month, a quarter or a year in which the contract was entered into until the end of the month, the quarter or the year when the property is sold or when the contract expired.

11. The contract according to claim 1, wherein the beneficiary is entitled to the payout upon sale of the property or at an end of the term of the contract when the index level increased since a time when the contract was entered into.

12. The contract according to claim 11, wherein the payout is a fixed amount or a proportion of the fee payable by the beneficiary, or a proportion of an appraised value of the real estate property at about the time when the contract was entered into and wherein the proportion is determined by an increase in the index level since the time when the contract was entered.

13. The contract according to claim 1, wherein the payout is limited to a certain maximum amount.

14. The contract according to claim 1, wherein when the real estate index declines since a time the contract was entered into, and the beneficiary has not sold the real estate property since a beginning of the term of the contract, the beneficiary is entitled to the payout during the term of the contract under conditions specified in the contract.

15. The contract according to claim 14, wherein the payout is a fixed amount or a proportion of the fee payable by the beneficiary, or a proportion of an appraised value of the real estate property at about the time when the contract was entered into and wherein the proportion is determined by an increase in the index level since the time when the contract was entered.

16. A contract wherein a contract writer agrees to pay a beneficiary a payout, wherein:
the payout is determined by an index level representing a price level of real estate properties in a predetermined area where the beneficiary owns a real estate property and where the right of the beneficiary to receive the payout is exercised upon a sale of the real estate property during a term of the contract, and
wherein the payout is only made at about a time when the index has increased since a time when the contract was entered into, and
the beneficiary agrees to pay the contract writer a fee.

17. The contract according to claim 16, wherein the payout is a fixed amount or a proportion of the fee paid by the beneficiary, or a proportion of an appraised value of the real estate property at about the time when the contract was entered into and wherein the proportion is determined by an increase in the index level since the time when the contract was entered.

18. The contract according to claim 16, wherein the fee is payable in whole or in part at the time the contract is entered into, or in whole or in part at the earlier of the sale of the real estate property or a refinancing of a mortgage loan on the real estate property.

19. The contract according to claim 16, wherein a legally binding document is executed placing an encumbrance on a title of the real estate property requiring satisfaction of the fee payable to the contract writer upon the earlier of the sale of the real estate property or a refinancing of a mortgage loan on the real estate property.

20. The contract according to claim 1, wherein methods and procedures of the contract are automated using computer software deployed on computer workstations, networks, or the Internet.

21. The contract according to claim 1, wherein the fee payable is pooled with other fee payables and converted into standard securities, backed by the fee payables, and issued in private or public capital markets.
